(19) United States
(12) Patent Application Publication
(10) Pub. No.: US 2007/0027852 A1
(43) Pub. Date: Feb. 1, 2007

(54) Smart search for accessing options

(75) Inventors: Dane M. Howard, Sammamish, WA (US); Lee Chuan Lin, Redmond, WA (US)

Correspondence Address: KLARQUIST SPARKMAN LLP, 121 S.W. SALMON STREET, SUITE 1600, PORTLAND, OR, 97204, US

(73) Assignee: Microsoft Corporation, Redmond, WA (US)

(21) Appl. No.: 11/249,235

(22) Filed: Oct. 12, 2005

Related U.S. Application Data
(63) Continuation of application No. 11/193,297, filed on Jul. 29, 2005.

(51) Int. Cl. G06F 17/30

(52) U.S. Cl. 707/3

(57) ABSTRACT

When an input device, which may be a portable communications device, receives a keyword input from a user, an advertisement associated with the keyword, and stored on the device, is displayed. Then, a signal is transmitted to a remote site which indicates that the advertisement was displayed. In some embodiments, an advertiser pays a fee associated with the advertising being displayed, and may also pay a fee to place the advertisement on the device. A user has the option of turning off the advertisements, and/or of being paid a fee when the advertisements are displayed on his or her device. Specific advertisements may be displayed based on the physical location of the device.

### CROSS REFERENCE TO RELATED APPLICATIONS

This is a continuation of U.S. patent application Ser. No. 11/193,297, filed Jul. 29, 2005. This application is incorporated herein in its entirety.

### COPYRIGHT AUTHORIZATION

A portion of the disclosure of this patent document contains material which is subject to copyright protection. The copyright owner has no objection to the facsimile reproduction by anyone of the patent disclosure, as it appears in the Patent and Trademark Office patent file or records, but otherwise reserves all copyright rights whatsoever.

### BACKGROUND

We, as a society, are incorporating mobile electronic devices into the fabric of our lives. More and more options are becoming available, for example, mobile devices may now include phone options, a media player, and a camera, and may also be connected to the internet, allowing for an almost unlimited range of applications, such as the phone feature set, games, e-mail access, a web browser, and web-based applications, such as downloading music, looking up location-specific information such as local movie times, local traffic reports, local weather, and so on.

At the same time the number of options on an average device has exploded, paradoxically, such devices have not increased in size, and in some cases have become smaller, often able to easily fit into a pocket. Often such devices have only a restricted keyboard—such as the typical twelve-key numeric keypad often found on cell phones—and a handful of navigation buttons. Due to screen size restrictions, not much data at a time can be displayed. This presents the question of how to easily find some desired device functionality. One method involves navigating through an ever-expanding series of menus to drill down to the application desired. This tends to be both time-consuming and non-intuitive.

### SUMMARY

This summary is provided to introduce a selection of concepts in a simplified form that are further described below in the Detailed Description section. This summary is not intended to identify key features or essential features of the claimed subject matter, nor is it intended to be used as an aid in determining the scope of the claimed subject matter.

In one embodiment, a method for intelligently searching through the myriad of options available on mobile electronic devices is presented. Mobile devices are often small enough that they have only a restricted keyboard, such as the numeric keypad found on many cell phones. A user can type in a character from that restricted keyboard, and it will be mapped to a fuller character set, such as the alphabet. In an exemplary embodiment, the numbers on the keypad will be mapped to the letters listed on the face of the keypad buttons, such that “2” maps to “A,” “B,” and “C,” “3” maps to “D,” “E,” and “F,” and so on. Therefore, to look up “DAD”, a user would type in “323”.

The fuller mapping is then used to search at least a subset of options available on the device, the options represented by keywords. Such options might be a device features, media application options, phone application options, calendaring options, and so forth. Other options such as useful programs available on the Internet, user-defined options, and, in some embodiments, keywords representing paid placements can also be accessed through the search. Once the search results are returned, they are sorted based on past user behavior and based on the context the device was in when the search was initiated. For example, if the device was in a phone state when the search was initiated, phone-type options (such as phone numbers and contacts) will appear higher within the search list. Keywords may also be given greater weight (resulting in a sort location easier for a user to find) based on the time a search occurs, the physical location of the device, and paid weightings. The sorted options are then displayed.

Additional features and advantages will become apparent from the following detailed description of illustrated embodiments, which proceeds with reference to the accompanying figures.

### BRIEF DESCRIPTION OF THE FIGURES

FIG. 1A is a diagram of a standard numeric keypad.

FIG. 1B illustrates an exemplary sample mapping between spoken input and reasonable guesses as to the input.

FIG. 2 illustrates an example display for performing a smart search.

FIG. 3 illustrates an exemplary sample mapping between a restricted character set and a full character set.

FIG. 4 is an operational flow diagram illustrating a method for using a keypad to filter a keyword search on a portable electronic device in conjunction with which described embodiments may be implemented.

FIG. 5 is a continuation of the operational flow diagram shown in FIG. 4.

FIG. 6 is a diagram used to illuminate some of the methods shown in FIG. 7.

FIG. 7 is an operational flow diagram illustrating a method to intelligently search for options on a portable media device in conjunction with which described embodiments may be implemented.

FIG. 8 is a functional block diagram illustrating an example system for modifying keyword search results in conjunction with which described embodiments may be implemented.

FIG. 9 is a block diagram of a suitable computing environment in conjunction with which described embodiments may be implemented.

FIG. 10 is a block diagram of a suitable communication device in conjunction with which described embodiments may be implemented.

FIG. 11 illustrates a sample display for displaying keyword search results.

### DETAILED DESCRIPTION

I. Overview

Systems and methods are presented herein for locating information quickly on a device with ambiguous input by mapping the ambiguous input onto a best guess set of keywords and then using the best guess perform a keyword search, where the keywords represent both contacts and other types of information, applications, and services available on the device. An exemplary embodiment comprises a restricted character set—the numbers 1-0—mapped onto a full character set, the letters of the alphabet and the original numbers.

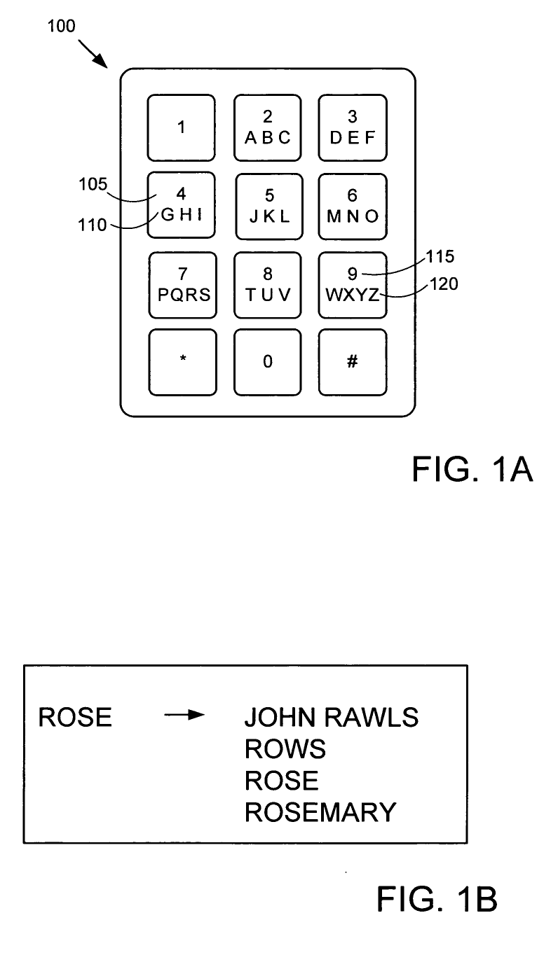

With reference to FIG. 1A, a restricted character set input device 100 is shown—a standard 12-key keypad, traditionally used for input on small portable devices, such as those incorporating cell phones. However, it should be understood that any input method—such as those with no keyboard, i.e., touching a touch screen, choosing items from a menu, and so forth; and those that use keyboards with different numbers of keys—may be used for character input. The number keys 2-9 maps onto the letters of the alphabet shown on a given key. So, key “4” 105 maps to the number 4 and the letters G, H, and I 110; while the key “9” 115 maps to the letters W, X, Y, Z 120, and the number 9. The number 1 is a wildcard representing any character.

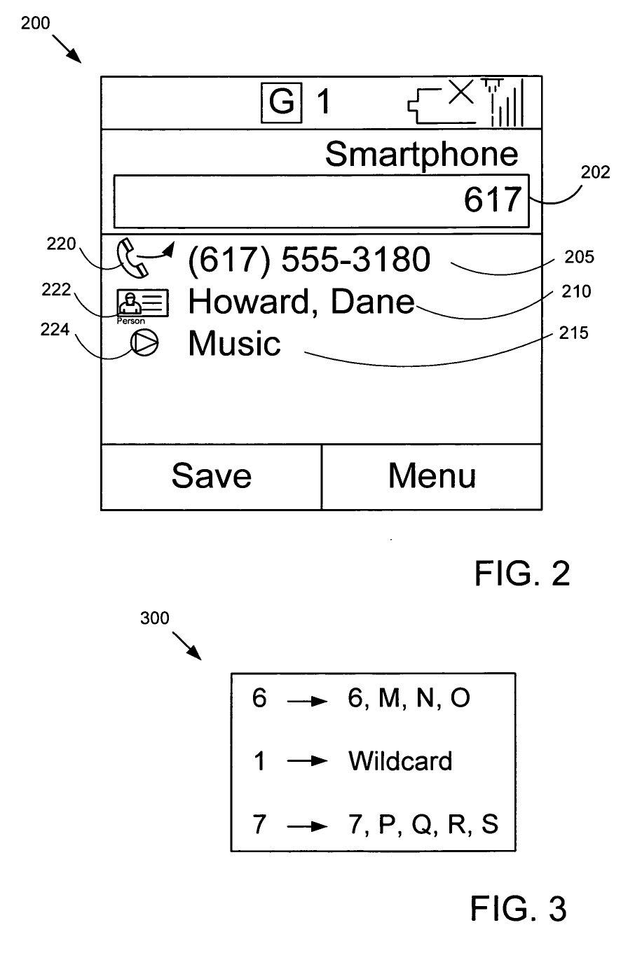

The user types a string of numbers into the device, and in response, the device displays a variety of keywords associated with the device, based in part, upon the characters typed, the context in which the user initially began inputting the character string, and upon the past behavior of the user. So, referring to FIG. 2, if the user typed “617” 202 on the device home screen, at least a subset of all possible keyword matches would be located, and then sorted. In the example shown in FIG. 2, the phone number “617-555-3180” 210 is matched directly, the name “Dane Howard”215 is also returned as a match as the phone number “617-555-3180” 210 is his number. The Music application 220 comes up as well, as the number “6” maps to the letter M, “1” maps to all letters, as a wildcard, and “7” maps to “S”, as shown in FIG. 3, producing “MUS”.

The ambiguous input can also be voice input, as shown in FIG. 1B. A user speaks the sound “ROSE” into a device, and the device maps the words shown—John Rawls, Rose, Floral Shop (sells roses) and Rosemary—onto the sound representation.

Handwriting recognition pads also produce ambiguous inputs—the written shapes may suggest a number of possible letters. In an exemplary embodiment, the shapes generated from a handwriting recognition pad may be used as the first ambiguous set, with the best guesses from the device mapped to precise options during the keyword search.

The current use state of a device is also given weight as to how the keyword matches are displayed. If the user had begun typing from a music application, then musical matches would be given more weight in the final sort than matches of other types. Information learned from past user behavior, such as the frequency that a given song had been played, may also go into the final sort of the matches. Similarly, the type of input used—keyboard, voice recognition, handwriting stylus, etc., may also be used to determine which matches will be considered more relevant. For example, if a voice recognition system is used for input, then options which utilize voice recognition may be sorted nearer the top.

Filters may also be applied, using the same criteria, to reduce the total number of matched keywords.

II. Exemplary Method for Smart Searching Applications and Systems

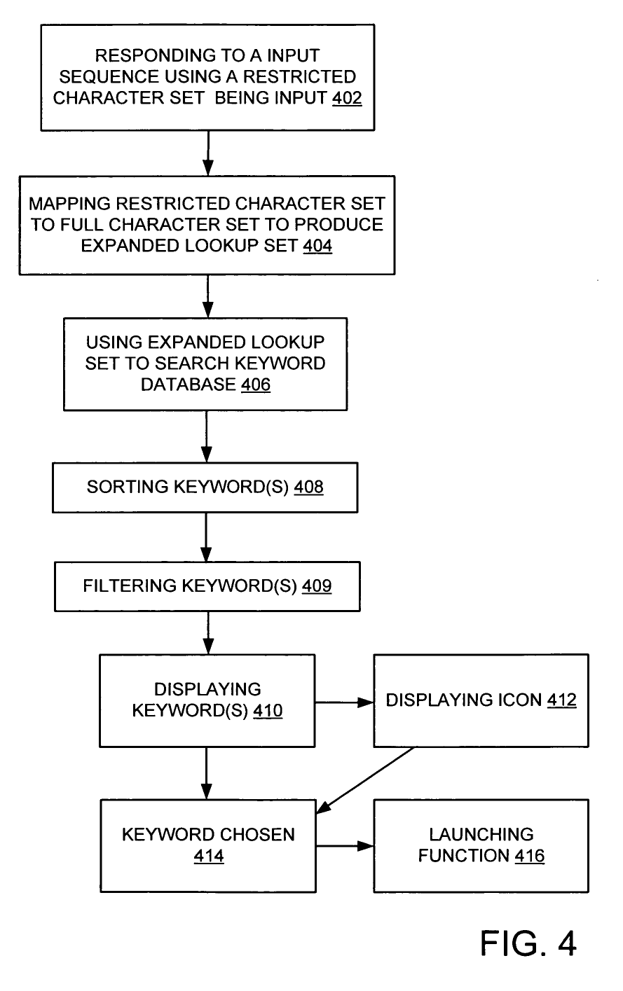

FIG. 4 is an operational flow diagram illustrating a process for using a keypad to filter a keyword search on a portable electronic device. The process begins at process block 402 where a portable electronic device responds to an input sequence of key activations associated with a restricted character set being input. In an exemplary embodiment, this restricted character set is the numbers 1-0 as found on the standard numeric keypad 100 as shown in FIG. 1. Other restricted character sets are envisioned, however. For example, certain character-based languages such as Chinese have systems where complex characters can be assembled using a series of predefined strokes—this “stroke alphabet” could be the restricted character set. A user may enter the character set using a touch-pad, by pressing a button, by writing on a tablet, by toggling a switch, and so on.

At process block 404, the restricted character set is mapped to a fuller character set. In the example given, the numbers on a keypad are mapped to the standard alphabet. Other alphabets may be used, such as the Cyrillic alphabet, or the Arabic alphabet, or something entirely different than an alphabet may be mapped, such as a list of commands, or a list of mathematical formulas. Some characters in the restricted character set may have special functions, such as a specific character may represent a wildcard. In an exemplary mapping, the wildcard is the number “1”, which maps to all 26 letters. In other mappings, the wildcard may map to all numbers as well as the letters, or may map to some restricted character sets. In some embodiments, there may be multiple wildcard characters.

This mapping produces an expanded lookup set 404. FIG. 3 shows an exemplary mapping. The user input “6” is mapped to the number 6, and the letters M, N, and O. The user input 1 is a wildcard which maps (in this case) to all 26 letters of the alphabet, and the user input “7” maps to P, Q, R, and S. In this exemplary embodiment, the number “6”, and the letters M, N, and O in the first position is mapped to each character in the full character set in the middle position, and to the characters 7, P, Q, R, and S in the third position giving the possible combinations “6 1 7”, “6 2 7”, “6 3 7”, . . . “6 9 7”, . . . “M A P”, “M B P”, “M C P”, . . . “M Z P” . . . “N A P”, “N B P”, “N C P”, . . . “N Z P” . . . to “O Z P”. It should be understood that three characters are input here simply for illustrative purposes; any number of characters can be input to be used within the mapping. The longer the character string, the fewer matches can be expected to be retrieved.

At process block 406, the expanded lookup set is used to search a database. This database may itself comprise many separate sub-databases. With reference to FIG. 2, an exemplary database has a number stored in the contacts database that begins with the digits “617”-“617-555-3180” 205. That contact number has a name associated with it, “Dane Howard” 210. This name also appears in the database search results. The keyword “Music,” which represents a music player application, also is returned as a result 215, as “6” maps to “M”, 1 maps to anything and “7” maps to “S”. If the keyword “Music” 215 is selected, then the Music Player application will immediately be launched.

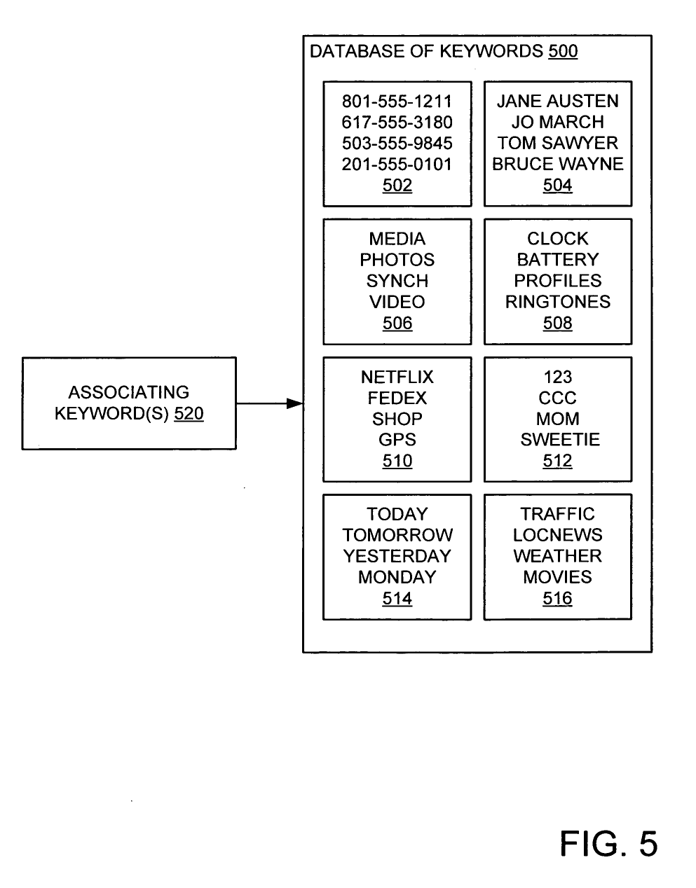

Turning to FIG. 5, the database 500 may itself contain keywords from a number of sources. As seen previously, the database may contain contact numbers 502, that is, numbers that have been input into the contact database. There may also be a name database 504 which may or may not be connected to the contacts database. Assuming that at least some of the contacts have associated names, inputting characters that represent the contact number should retrieve the name, and vice-versa. So, in the example shown in FIG. 2, inputting “4 6 9” (H O W) or “3 2 6 3” (D A N E) should bring up both Dane Howard's name and his contact number.

The features available on the media device may also have keywords associated with certain device applications 506; such keywords, for example, being “Music” which may bring up a music player on some devices, as discussed above. Other keywords in this group may be such words as “Photos” (to view stored photos) “Synch” (to synch this device with another device) “Camera” (to start a camera function), “Calendar” (to start a calendaring application) and “Video” (to start a video application), to name a few. In an exemplary embodiment, when a keyword representing such a device application is chosen, the application is launched.

Device functions 508 may also have associated keywords. For example, rather than having to access several levels of menus to access the clock function, the keyword “Clock”, when chosen, could automatically allow a user to modify the device clock. A given application can have multiple keywords associated with it. For example, the clock could also be accessed by the following keywords: “time”, “timezone”, and “date”, if all are attributes of the device clock. Other device functions, such as messages, the call log, battery information, profiles, and changing ringtones, to name a few, could have keywords associated with them that allowed easy access to them.

Commercial services may also have associated keywords 510. For example, a music download site, YOURDOWNLOAD, could have the keyword “DOWNL” associated with it. In an exemplary embodiment, a commercial service could pay to have a keyword associated with its service 520 installed upon at least one device. So, for example, a major internet cataloger could purchase the word “SHOP” such that when device users selected that keyword, an application takes the user's device by, for example, an internet connection, to the cataloger's site. Similarly, a paid placement for “local traffic” may lead to a specific information or site. Furthermore, the specific site that the keyword leads to may be controlled by the device access carrier, so that the site (or information) that the keyword leads to can be modified without a user's input.

Users can also input their own keywords, 512 and connect them with a desired functionality; this allows a user to personalize a device. Users may choose to associate keywords with favorite internet sites, with email applications, with specific people, and so on.

A special class of keywords associated with time 514 can also be part of the database. For example, the word “Monday” could represent the relative concept “next Monday” and could pull up all calendar events occurring on that day. Other such relative time concepts such as “yesterday”, “today”, “tomorrow” “next week”, “last Tuesday”, etc., could also be included.

Keywords representing the physical location of the device 516 can also be present. For example, such a physical location-dependent keyword could be “Traffic”. When “Traffic” is pulled up out of the database and then selected, the state of traffic in some geographic area around the device could be displayed. The concept of local could be dependent on the actual device location or could be input by a user. Other location keywords might be “Movies” (pull up movies within 5 miles of the user's home), “Sushi Bars” (pull up sushi bars within the user's city), “Weather”, etc.

Keywords can be installed from a remote location using, for example, a wireless network convention. A phone company could install keywords for new services available, or a company Information Technology administrator may install keywords to allow employees to quickly access company Information Technology services.

Keywords may be associated with a paid advertiser. Advertisers may pay money to have a keyword associated with them, and with an advertisement that is on the device. When the user chooses a keyword associated with a specific advertiser, an advertisement associated with the advertiser will be displayed on the device. The advertisement may be kept in a database of advertisements 634, and there may also be an associated ad filter 632. If so, the advertisement may be associated with a keyword. The keyword and advertisement may be present on the device initially, may be downloaded by the user, may be downloaded by the user for a payment to the user, or may be downloaded without the user's knowledge using a network, such as a wireless network.

The user may disable this function, so that no ads are displayed, or that only specifically opted-in ads are viewed. Some ads may be location-dependent, that is depending upon the physical location of the device, a different ad may be displayed. As an example, a pizza chain may display an ad with the address of the pizza restaurant closest to the physical device location.

The advertisement may be displayed on a screen prior to any other content associated with the keyword, may be displayed after the user exits the content associated with the keyword, may be displayed by playing an ad or a musical selection, or may be displayed in some other fashion.

When an advertisement is displayed, an indication reflecting that the ad has been viewed will be communicated to the advertiser, and the advertiser may have to pay a fee. This communication may be stored on the device or may be sent immediately to an offsite location. Alternatively, a certain number of ad view information may be stored and then sent, or the ad view information may be sent only at certain times. If the ad view is associated with a fee it may be paid to a wireless communication provider, an advertising service, or some other service.

When information is sent back to the advertiser concerning the viewing, it may contain personally identifiable information reflecting the specific device or the specific user. Some embodiments also include the option allowing the user to disable this function so that the user is not identified to outside sources. In other embodiments, the function is, by default, disabled, and a user must specifically opt-in for identification to be passed to outside sources. This opt-in option may be accompanied by a fee paid to the user for choosing that function.

Users can further personalize their keyword searches by disabling chosen aspects. For example, a user could instruct the device to not return any keywords associated with internet sites, not return any keywords associated with a specific device function, such as turning off all keywords associated with contacts, and so on.

With reference to FIG. 4, at optional process block 408, the keywords that were selected from the database are sorted. These keywords may be sorted alphabetically, or they may be sorted based on past device activity history, or some other combination. For example, if the numbers “617” were typed in as the character search string there might be 20 phone numbers that started with that prefix. However, one of them might have been dialed 20 times in the last month, and 10 might have not been called for the last four months. The device may therefore sort the numbers by the frequency of use, with later uses being given more weight than those that happened further in the past. With such a sort, the number most frequently dialed should appear first (or near the top) of the list.

The state the device was in when the keyword search was initiated may also influence the sort order of the returned keywords, or may influence which keywords are chosen. For example, if the device was in a listening to music state, then song titles and/or song lists that matched the input string might be favored, similarly, if the device was in a looking at pictures state, then picture titles might be sorted closer to the top.

Keywords can also be filtered, as shown at optional process block 409. For example, a filter may filter out all keywords which are not applicable to the current device state. In another embodiment, a subset of keywords may be filtered out, with a core set of keywords always available. Time may also be used for a filter, with events occurring prior to a certain date being filtered out. So, for example, appointments whose date is in the past may be filtered out. Similarly, phone calls that were made over a year ago may not be displayed. Physical device location may also be used as a filter, with keywords that represent services within a geographic area sorted for.

At process block 410, the keywords are displayed in such a way that a user can select one of them. A screen on a portable device may be too small to show the entire list of keywords returned from the search, especially if the search string was small, and the database of keywords is large. Therefore, there should be an associated scroll function to easily allow a user to view the entire list.

Additionally, interface elements may be introduced to allow a user to “pivot” (horizontally or vertically) to additional contexts while maintaining the original search text. For example, a user may type “7 2 3 4 6” (radio) and get radio settings (a device setting) as a choice. The GUI (graphical user interface) may include an ability to “pivot” to other types of media allowing the user using a “pivot widget” to search for music, photos, and so on, depending upon which pivot category (optionally represented by icons) is selected. An example of such a pivot widget can be seen in FIG. 11. Data is entered in an “accumulator” 1105. As the user enters data, the icons 1110 for data types with matches may change state, by getting bigger, by changing color, by having a label that indicates that the icon contains matches, and so on. As the character string gets longer and matches are eliminated, an icon whose category is now empty reverts to its initial, non-match state. Alternatively, a match may be indicated by populating the pivot widget with only those icons that contain matches.

Returning to the “radio” example, if the user were to pivot to the music library icon, the search might return “Radiohead”, the name of a rock band inside the device library. In another embodiment, various search categories may be displayed simultaneously, as is shown in FIG. 11, where the categories Automotive 1115, Restaurants 1125, and Websites 1135 are all displayed, along with the keywords 1120, 1130, 1140 that match the character string (3283) in the accumulator 1105. Each keyword begins with “DAVE”, and has an associated function, the function being launched when the keyword is chosen. For example, if Dave's TVReviews.com 1140 is chosen by a user, the device preferably will launch an internet application that will connect the device with the TVReviews website.

At optional process block 412, an icon is displayed. Examples of such icons can be seen in FIG. 2 at 220, 222, and 224. Sometimes, a given icon is associated with a class of keywords, such that all contact phone numbers have the same icon 220, all people have the same icon 222, and so on. This gives the users a visual clue as to what category a given keyword fits in. This can be seen as especially useful when someone is confronting a keyword they've never seen before, because it was added by an application or by a commercial service.

At optional process block 416, a function associated with a specific keyword may be launched. Some keywords, such as application keywords and commercial services keywords may have functions associated with them, and these functions may be immediately activated when the appropriate keyword is chosen.

In an exemplary embodiment, this restricted character set is the numbers 1-0 as found on the standard numeric keypad 100 as shown in FIG. 1. A user may enter the character set using a touch-pad, by pressing a button, by writing on a tablet, by toggling a switch, and so on.

III. Exemplary Method to Intelligently Search for Options on a Media Device

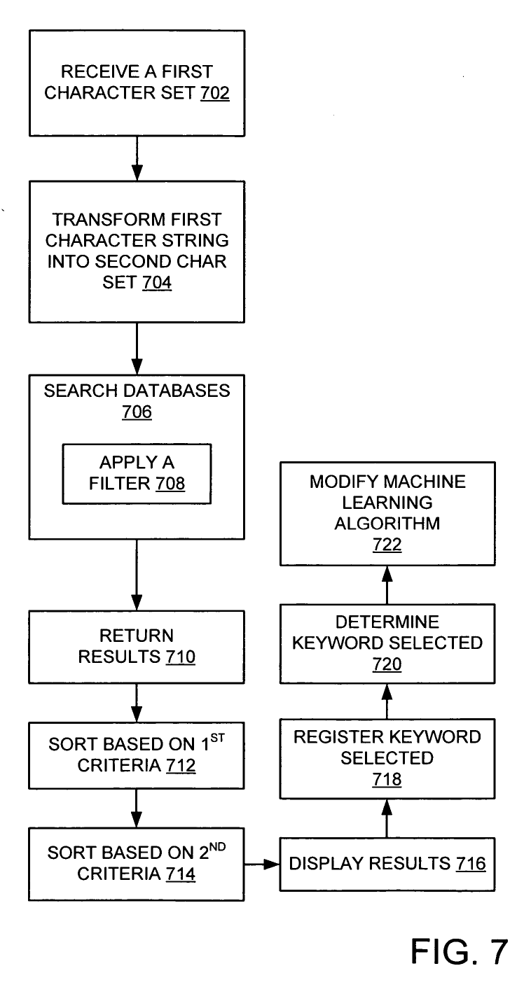

FIG. 7 is an operational flow diagram illustrating a process for using a keypad to filter a keyword search on a portable electronic device to intelligently search for options on a media device. The process begins at process block 702 where the device receives a first character string, the string having a context. The character string can be a single character, such as the character “6”, or can be a much longer string, such as the string “467743”. The context of the string is, in an exemplary embodiment, the state the portable electronic device was in when the search was initiated. For example, the context could be a phone application, a media application, a camera application, an email application, a text-messaging application, a calendaring application, or a commercial service, etc. The state could also refer to the specific portion of an application that was being referenced, such as within a video streaming application within the media application, within the address field of an email application, viewing photos within a camera application, at the call log within the phone application, and so forth. The process continues at process block 704.

At process block 704, a first character string is transformed into a second character string. For example, as previously discussed with reference to FIG. 1, a limited character set is transformed by being mapped to a larger character set. In such a case, the number “4” maps to the letters G, H, and I. In an alternate embodiment, the transformation maps two roughly equal character sets. In such a case, the English alphabet may be mapped onto the French alphabet, with each English letter (the first character string) transformed into the corresponding set of French letters including those with diacritical marks. So, the “È” would map to “É”, and “Ê”. The process continues at process block 706.

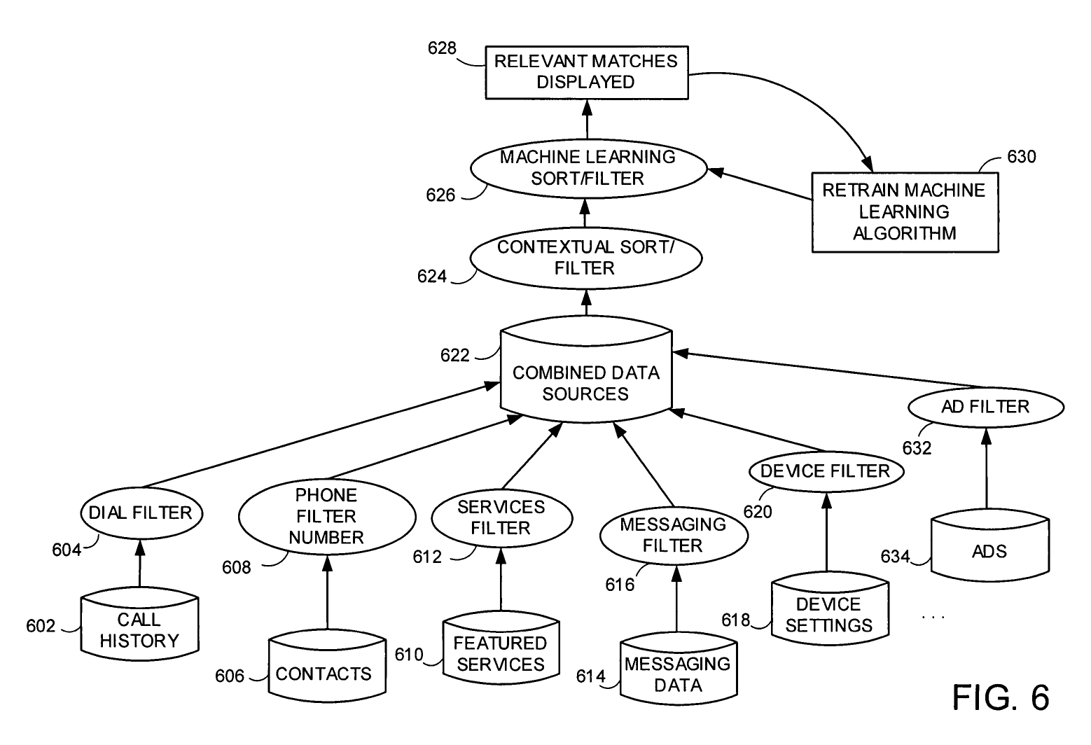

At process block 706, the second character string is used to search at least three databases by applying a filter 708. With reference to FIG. 6, a number of databases and filters are shown that can be used with this embodiment. Although each filter, in an exemplary embodiment, is based on the second character string, each database has at least the potential to have its own filter. These database-filter sets include a call history database 602, composed of both dialed numbers, and, in some embodiments, the times the calls were made; and a dial filter 604 which might include a way to connect dialed, received, and missed call numbers to their corresponding contact. Another database is the contact database 606, and its corresponding phone number filter 608 which may include ways to connect the contacts with the corresponding phone numbers that relate to it. Another database (not shown) may be a time database that filters contact information and phone calls based upon the time calls were made. As an example, typing in “TODAY” (86329) may sort for calls that were made today, and may also sort for their corresponding callers. It may also sort for device features that were accessed today, calendar items with today's date, and so on.

Yet another database may be the featured services database 610 and its corresponding filter—Services Filter 612. The featured services database 610 may be composed of services that paid to have a correspondence between them and keywords that correspond in some fashion to the second character string. For example, a mapping software program, say, “Mappie”, may have paid for the word “Mappie”, and “Map”, both of which start with the number entry “627”. The filter “Services Filter” 612 may give greater weight to those services that paid for a higher placement.

Messaging data 614 may have its own database and filter, “Message Filter,” 616. Other database and filter sets, such as a device database 618, and its Device Filter 620, filled with keywords for accessing features on the device, such as tone settings, profiles, time and data settings, ring tones, wallpaper, and the like.

At process block 710, the results of the various database searches are returned and consolidated to combine the data sources, as shown at 602. In some embodiments, such as if a pivot widget is used, the data sources are not combined, but rather remain distinct. Then when the results are sorted, below, each data source is sorted independently. An example of this can be seen in FIG. 11.

At process block 712, the results are sorted based on a first criterion. This criterion could be either a context algorithm 624, a machine learning algorithm 626, an alphabetization sort, and so on. If the results are sorted based on a context algorithm 624, then those results that are related to the specific portion of the device that is being accessed by a user (the context) are given greater weight than the others. For example, if a user is making a phone call, then the context search will give preferential treatment to phone numbers and contacts as opposed to the names of pictures, the names of songs downloaded on the device, and so forth. Other items that may go into a context algorithm 624 include the time, so that even if the user was in a photo application when a search was initiated, if the current time is very close to an appointment, the appointment may be given preferential treatment. The physical location of the device (as determined by, for example, a global positioning system within the device) may also be considered by the context sort, with locations in the vicinity of the device being given preference over those located farther away.

If the first sort criterion is a machine learning algorithm 626, then the history of access on the device is taken into account. For example, numbers called more recently, applications accessed more often, and the like, are considered, so that a song that has been downloaded, but never listened to, will most likely not be at the top of a given list. Weightings can be assigned to keywords that give them more or less relevance as well. For example, a company may pay to have a specific keyword added to the database and then given a high relevance weighting, so it will be returned higher on a search list than it would otherwise be. The company associated with a specific device may also weight certain search terms so that their associated products appear higher on search lists.

At process block 714, the list is again sorted using a different criterion. This may be whichever from among the context filter/sort 624 and the machine learning filter/sort 626 was not performed in the first sort 712, or may be a different sort altogether.

At process block 716, the relevant matches are displayed 628 on a screen associated with the device. At process block 718, the device registers that the user has selected a keyword. It then determines which keyword was selected at process block 720, and at process block 722, retrains the machine learning algorithm 630 to reflect this new information. Generally the retraining of the machine learning sort/filter is treated as an unsupervised machine learning problem. There are many suitable algorithms, such as decision trees, genetic algorithms, neural nets, Bayesian learning, Computational learning, instance-based learning, analytical learning, and so on that can be used as the underlying unsupervised machine learning algorithm.

Keywords are associated with options. These options also have associated weights. When a user inputs a search, a list of search keywords is returned. If the user does nothing with a keyword, it is given a very low (or negative) weight. If a keyword is browsed but not eventually chosen, it is given a higher weight. The keyword that is chosen, often referred to as “the high payoff function”, is given the highest weight.

The weights are then redone so that the next time a similar list of keywords is returned, the chosen keyword should be at or near the top of the list, and the browsed items should also be near the top of the list.

Keywords (or their underlying options) can have an initial weight. This weight could be assigned based on a commercial service paying a fee for the privilege. Alternatively, when a device is new, the weightings may be tweaked such that common user startup functions have higher weightings. In some systems, users can weight options directly.

IV. Exemplary System for a Smart Search

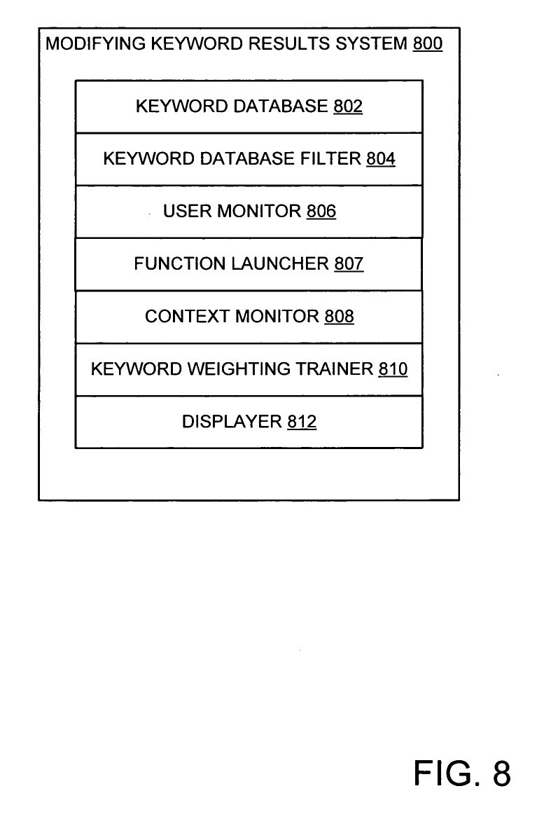

Referring to FIG. 8, a block diagram of a system for modifying keyword search results 800 shows an exemplary embodiment of the systems discussed herein. The system in an exemplary embodiment is a portable media device with a cell phone and a display which allows a user, at a minimum, to type search terms, to read and scroll through a list of keywords returned from the keyword database 802, and to easily select a keyword from the list. The user initiates a search action, by, for example, typing a string of characters. These characters may include special “wildcard” characters. The system consists of, at a minimum, a keyword database 602 which hold keywords representing functions available on the portable media device, applications and services available on the Internet or elsewhere, keywords entered by an application or a service, user-entered terms, phone numbers in the contacts database, contact names, date-sensitive terms such as “today”, location-sensitive terms, and so forth. These keywords include items such as those shown in Table 1, below.

TABLE 1

| KEYWORD | LINKS TO | KEYWORD | LINKS TO |
|---|---|---|---|
| MSN | Pocket MSN splash | glance (setup) | glance view setup |
| MSN Messenger | Messenger sign-in | Share (photos) | photo stories |
| MSN Search | search | photos (share) | photo stories |
| MSN Spaces | MSN Spaces | photos (from friends) | photo sharing service |
| IM | Messenger sign-in | photos (view) | photo viewer |
| Chat | Messenger sign-in | Slideshow | photo viewer |
| Instant Messenger | Messenger sign-in | maps | mapping software discovery |
| Text | Text Messaging | Directions | mapping software discovery |
| chat setup | 3rd party chat setup wizard | location | mapping software discovery |
| SMS | Messenger sign-in | find (me) | mapping software discovery |
| SMS setup | 3rd party chat setup wizard | gps | mapping software discovery |
| Buddies messenger | Messenger sign-in | shop (around me) | mapping software discovery |
| buddies near me | buddie finder app | shop (groceries) | vons club app discovery |
| Media | Media Player | shop (apps) | Marketplace |
| Video | video playlists | marketplace | Marketplace |
| outlook | outlook e-mail box | search | go to search |
| outbox | e-mail outbox | upgrade | About screen |
| mail | Messaging | balance (bank) | bank balance app |
| mail setup | mail configuration help | money (market) | stock market app |
| hot | Hot mail splash | stocks | stock market app |
| sent mail | sent Items (mail) | market (stock) | stock market app |
| sent text | sent items (text messages) | mutual funds | stock market app |
| sync | active sync splash | PC (my) | browse my PC app discovery |
| active | active sync splash | my (PC) | browse my PC app discovery |
| browse | PIE splash | my photos | photo viewer |
| PIE | PIE splash | 911 (VIP) | emergency contacts |
| favorites | My Favorites | 911 (emergency alerts) | emergency alert services |
| my windows Mobile | sign into my windows mobile | games | games category |
| sync | synchronize app | recommended (services) | rec category in apps catalog |
| ringtones change | sound settings | local (guide) | local guide application |
| ringtones find | apps catalog (tones, latest) | weather (local) | local weather app |
| tones find | apps catalog (tones, latest) | local (weather) | local weather app |
| tones change | sound settings | today's (weather) | local weather app |
| profiles | profile settings | today (schedule) | today's calendar view |
| home screen | home screen settings | fun (downloads) | fun downloads |
| clock | clock & alarm settings | fun (comics) | comic app discovery & config |
| battery | Power mgmnt settings | parking (meter) | parking meter app |
| language | Regional settings | parking (cheap) | mapping software discovery |
| about this phone | About settings | snow (report) | local snow/ski conditions |
| call Barring | Call barring setting | ski (report) | local snow/ski conditions |
| call forwarding | call forwarding setting | road (report) | local traffic app |
| call waiting | call waiting setting | news | news feed download |
| caller ID | caller ID setting | news (local) | news feed download |
| ID caller | caller ID setting | Movie (times) | local movie timesapp |
| connection settings | Connection settings | Sports (scores) | sport scores app |
| settings | Device settings | horoscopes | horoscopes app |
| tomorrow | Go to tomorrow | google | google search field |
| Monday (next) | Go to (relatively) next Mon. | google SMS | google sms service |
| Tuesday (next) | Go to (relative) next Tues. | Netflix | netflix video service app |
| Wednesday (next) | Go to (relative) next Wed. | shipping | fed ex tracking app |
| Thursday (next) | Go to (relative) next Thurs. | fedex | fed ex tracking app |
| Friday (next) | Go to (relative) next Friday | tracking (package) | fed ex tracking app |
| Saturday (next) | Go to (relative) next Sat. | package (tracking) | fed ex tracking app |
| Sunday (next) | Go to (relative) next Sun. | clocks (download) | clock app chooser |
| Appointment (new) | create new appointment | time (faces) | clock app chooser |
| Tasks | Go to tasks | restaurants (local) | local restaurant app guide |
| 611 (about phone) | about this phone | local (restaurants) | local restaurant app guide |
| 611 (tutorial) | client | gas (cheap) | cheapest gas app |
| Help | Smart Phone How To | music (playlists) | my music playlists |
| Help (mail setup) | quickstart guide | music (my DJ) | my personal DJ |
| music (my) | my music place | traffic (local) | local traffic app |
| music (downloads) | music services | happy hour | local happy hour app |

The system also contains a keyword database filter 804 which aids in performing a keyword search based upon the user search action 802. This filter may filter out all keywords that don't fit a certain criteria, such as keywords associated with device function that have never been used, keywords not associated with the current device state, keywords associated with calendar events in the past, keywords that the user has chosen to turn off, and soon.

A user monitor 806 which records which keywords a user has chosen in response to the keyword search is also included. When the system knows which keyword was selected, a function launcher 807 optionally launches the associated function. For example, if the keyword “clock” were selected, the device clock and alarm setting application would be launched, allowing a user to update such functions. Not all keywords result in an application launch. If a phone number were selected, the number would not be immediately dialed, in some embodiments.

Similarly, a context monitor 808, which records a context in which the keyword search took place, is also included. This context refers to the state the device was in when the keyword search took place. It may be defined narrowly—such as the specific song a user was listening to when the search was begun, within a mid-range—the specific music application that a user was listening to; or broadly—the fact that the user was in a media application. The user monitor 806 and the context monitor 808 are used by the keyword weighting trainer 810.

The keyboard weighting trainer 810 modifies a weighting of one or more keywords using input from the context monitor 808 and the user monitor 806. A keyword with a stronger weighting will be preferentially displayed over a keyword with a weaker weighting. This way, a device “learns” what applications, services, people, and so forth, are accessed more often, and modifies the options displayed for a user for a given key input search based on past behavior.

Furthermore, certain keywords could be initially given a weighting. This initial weighting could be input by a user, input to make typical startup applications easier to locate, or such initial weighting could be given keywords related to preferred vendors.

In an exemplary embodiment, the keyboard weighting trainer 810 uses an unsupervised machine learning algorithm to learn behavior and to display the filtered list of options. Suppose that the user enters a search string that returns a list of 15 possible matches. A device has enough space on the screen to show a subset, 5. of those 15 matches. The remaining hidden matches may be reached by pushing a “More” soft button.

Before displaying the matches, the device must sort them in decreasing order of relevance; that is, the option the user is most likely to select should be first, the next most likely chosen option is second, etc.

In one embodiment, this “smart sorting” is performed as a problem in unsupervised learning, a subset of machine learning. Like all unsupervised learning systems, the smart sort trains itself by observing and remembering the results of previously made choices. Though unsupervised, the learning is governed by a “reward”—the specific match chosen by a user. For each decision, the smart sort bases its choice on the outcome of previously encountered similar situations. For example, the smart sort tracks which match the user selected so that the next time the device must sort a similar group of matches, the smart sort will change its sorting logic so that the selected item will be closer to the front of the list.

In any unsupervised learning algorithm, the device must have a way of evaluating its own choices. The smart sort system evaluates its sorting algorithm based on several factors, all having to do with the users' response to the list of returned matches. When the user selects the first match on the list and uses the associated service, then the system would give that outcome the highest possible evaluation (and the sorting would probably not change the next time that situation arose). If the user selects the match and browses the service but does not actually use it, the system would give that outcome a lower evaluation. If the user skips past the first match completely and chooses one of the later matches from the list, then the evaluation of the outcome would be a function of how far down the list the user had look in order to find the right service.

One possible solution uses a reinforcement learning algorithm for implementing both the sorting and learning described above. Reinforcement learning strikes a balance between two goals of learning: exploitation and exploration. In exploitation, the system leverages its previous knowledge to make a good decision, and in exploration, the system tries new choices hoping to find a better outcome than previously observed. Reinforcement learning algorithms bridge together both exploration and exploitation by using randomizing algorithms for selecting the keywords weighted by their relevance score and by modifying the relevance score in response to the user's action. Exploitation is used by giving high relevance to the users' previously selected keywords. Exploration is used by occasionally displaying to the user new keywords that were previously lower on the list and likely unseen by the user.

In one implementation, for each of the various context filters, a relevance database assigns every option (associated with a keyword) with an initial score ranging from 0 to 100.

The following list conceptually describes performing a sort on a list of items and filling the resulting sorted list.

1. Gather the list of matching items from each individual data source.

2. Sort first based on any context filter requirements. The remaining steps describe how to sort items within each context group.

3. For each item, query a relevance database for the item's weighting (for that context). This relevance database should hold a numeric score. Relevance scores can be changed outside the machine learning algorithm context. For example, certain items can be given higher initial relevance scores, certain items associated with keywords can be given artificially high relevance scores by having the score purchased, and so on.

4. Normalize each score so the sum of the scores is 1.000

5. Randomly select one of the items to be at the top of the next available space in the sorted list where the probability of selecting each item is the normalized score.

6. Sort the rest of the items by following steps 3-5 until all the items are in the list.

7. Track the user's response to our sorted list and determine which items the user ignored, browsed, and executed.

8a. The executed selection gains a score of (100+10n) where n is the number of items that were sorted ahead of it and ignored.

8b. All selections that were ahead of the executed selection in the list but which were browsed receive a score of 50

8c. All selections that were ahead of the executed selection in the list and ignored receive a score of −10

9. Update each score in the relevance database by calculating the running average score of each item including the newly assigned scores.

10. Update the relevance database to be prepared for the next sort. Set any scores that are less than 0 to 0; and set any scores that are greater than 100 to 100.

As an example, suppose there are three matching keywords for a given search with the following relevance scores:

CAMERA (100)

CALCULATOR (50)

BATTERY SETTINGS (50)

The normalized scores are each score divided by their sum, 200.

CAMERA (0.50)

CALCULATOR (0.25)

BATTERY SETTINGS (0.25)

When determining which keyword to display at the top of the list, the device will randomly choose the CAMERA keyword with probability 0.50, the CALCULATOR keyword with probability 0.25, and the BATTERY SETTINGS keyword with probability 0.25.

We shall assume that the random choice was BATTERY SETTINGS. Next, the device must determine which keyword to show second. The normalized scores of the remaining items are:

CAMERA (0.67)

CALCULATOR (0.33)

The device will now randomly choose between CAMERA with probability 0.67 and CALCULATOR with probability 0.33. Assuming the device chose CAMERA, the sorted list is:

BATTERY SETTINGS

CAMERA

CALCULATOR

Now, the user decides to launch and use the CAMERA, ignoring the top match, BATTERY SETTINGS. We consider BATTERY SETTINGS an ignored keyword and CAMERA an executed keyword (CALCULATOR is not considered ignored because it was below the eventually executed keyword). We assign a score of −10 to BATTERY SETTINGS and a score of +110 to CAMERA. Now suppose that the values in the relevance database had been the result of having selected CAMERA 5 times previously and BATTERY SETTINGS 1 time previously. Now the device calculates the running averages and updates the relevance database with the new scores.
CAMERA=(5*100+110)6=101.67=100(maximum allowed value)
BATTERY SETTINGS=(1*50+(−10))/2=20
CALCULATOR=unchanged=50

A displayer 812 is also included which displays keyword search results based upon the sort order determined by the keyboard weighting trainer 810. An example displayer 812 is shown in FIG. 11. Exemplary methods of displaying more heavily-weighted keywords include changing the font of the preferred keyword, playing a melody when the keyword is highlighted, and so on.

After the user chooses a keyword, the keyboard weighting trainer uses the information from the user monitor 806 and the context monitor 808 to modify the weighing algorithm to take the user behavior into account; this new information will be used the next time a keyword search is performed.

IV. Computing Environment

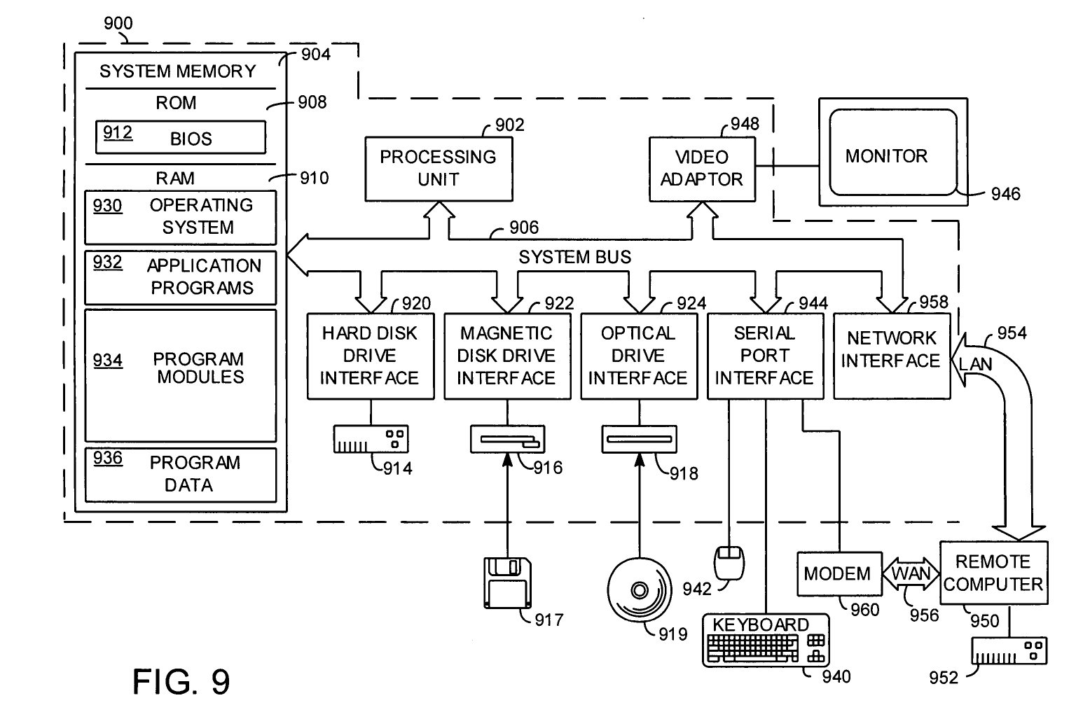

FIG. 9 and the following discussion are intended to provide a brief, general description of an exemplary computing environment in which the disclosed technology may be implemented. Although not required, the disclosed technology was described in the general context of computer-executable instructions, such as program modules, being executed by a personal computer (PC). Generally, program modules include routines, programs, objects, components, data structures, etc., that perform particular tasks or implement particular abstract data types. Moreover, the disclosed technology may be implemented with other computer system configurations, including hand-held devices, multiprocessor systems, microprocessor-based or programmable consumer electronics, network PCs, minicomputers, mainframe computers, and the like. The disclosed technology may also be practiced in distributed computing environments where tasks are performed by remote processing devices that are linked through a communications network. In a distributed computing environment, program modules may be located in both local and remote memory storage devices.

With reference to FIG. 9, an exemplary system for implementing at least portions of the disclosed technology includes a general purpose computing device in the form of a conventional computer 900, which may be a PC, or a larger system, including a processing unit 902, a system memory 904, and a system bus 906 that couples various system components including the system memory 904 to the processing unit 902. The system bus 906 may be any of several types of bus structures, including a memory bus or memory controller, a peripheral bus, and a local bus using any of a variety of bus architectures. The system memory 904 includes read only memory (ROM) 908 and random access memory (RAM) 910. A basic input/output system (BIOS) 912, containing the basic routines that help with the transfer of information between elements within the computer 900, is stored in ROM 908.

The computer 900 further includes one or more of a hard disk drive 914 for reading from and writing to a hard disk (not shown), a magnetic disk drive 916 for reading from or writing to a removable magnetic disk 917, and an optical disk drive 918 for reading from or writing to a removable optical disk 919 (such as a CD-ROM or other optical media). The hard disk drive 914, magnetic disk drive 916, and optical disk drive 918 (if included) are connected to the system bus 906 by a hard disk drive interface 920, a magnetic disk drive interface 922, and an optical drive interface 924, respectively. The drives and their associated computer-readable media provide nonvolatile storage of computer-readable instructions, data structures, program modules, and other data for the computer 900. Other types of computer-readable media which can store data that is accessible by a computer, such as magnetic cassettes, flash memory cards, digital video disks, CDs, DVDs, RAMs, ROMs, and the like (none of which are shown), may also be used in the exemplary operating environment.

A number of program modules may be stored on the hard disk 914, magnetic disk 917, optical disk 919, ROM 908, or RAM 910, including an operating system 930, one or more application programs 932, other program modules 934, and program data 936. A user may enter commands and information into the computer 900 through input devices, such as a keyboard 940 and pointing device 942 (such as a mouse). Other input devices (not shown) may include a digital camera, microphone, joystick, game pad, satellite dish, scanner, or the like (also not shown). These and other input devices are often connected to the processing unit 902 through a serial port interface 944 that is coupled to the system bus 906, but may be connected by other interfaces, such as a parallel port, game port, or universal serial bus (USB) (none of which are shown). A monitor 946 or other type of display device is also connected to the system bus 906 via an interface, such as a video adapter 948. Other peripheral output devices, such as speakers and printers (not shown), may be included.

The computer 900 may operate in a networked environment using logical connections to one or more remote computers 950. The remote computer 950 may be another computer, a server, a router, a network PC, or a peer device or other common network node, and typically includes many or all of the elements described above relative to the computer 900, although only a memory storage device 952 has been illustrated in FIG. 9. The logical connections depicted in FIG. 9 include a local area network (LAN) 954 and a wide area network (WAN) 956. Such networking environments are commonplace in offices, enterprise-wide computer networks, intranets, and the Internet.

When used in a LAN networking environment, the computer 900 is connected to the LAN 954 through a network interface 958. When used in a WAN networking environment, the computer 900 typically includes a modem 960 or other means for establishing communications over the WAN 956, such as the Internet. The modem 960, which may be internal or external, is connected to the system bus 906 via the serial port interface 944. A wireless network may also be used. In a networked environment, program modules depicted relative to the computer 900, or portions thereof, may be stored in the remote memory storage device 952. The network connections shown are exemplary, and other means of establishing a communications link between the computers may be used.

V. Communication Device

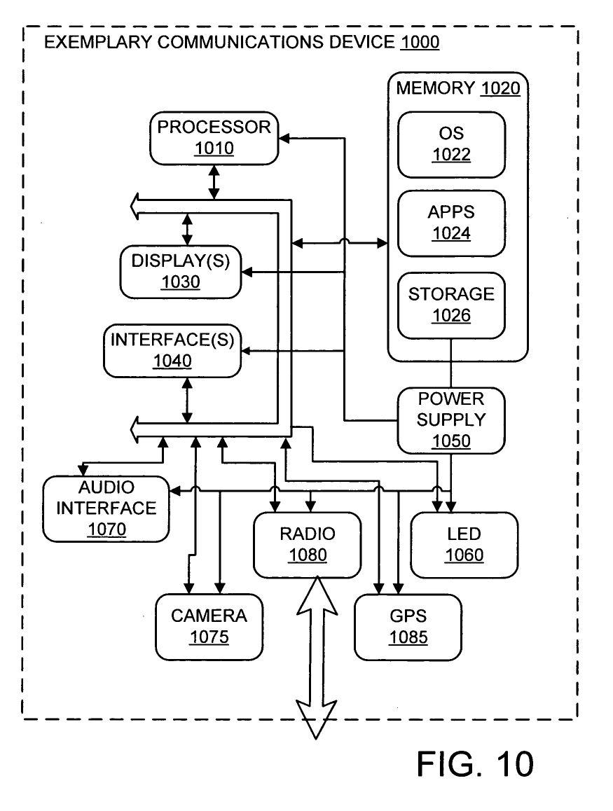

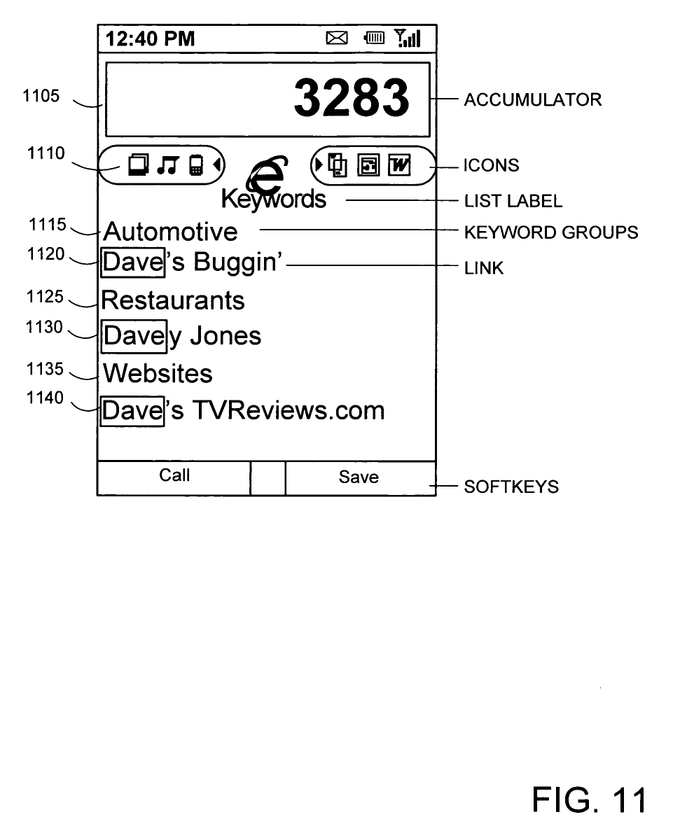

The computing environment may be in the form of a communication device, such as the communication device 1000 illustrated as a functional block diagram in FIG. 10. In one implementation, the communication device 1000 is a portable mobile communication device. The communication device 1000 may be implemented as one or more desktop personal computers, multiprocessor systems, microprocessor-based or programmable consumer electronics, network PCs, and the like, such as those discussed with reference to FIG. 9.

The communication device 1000 may include many more components than those shown in FIG. 10. The components shown, however, are sufficient to disclose an illustrative embodiment for implementing the disclosed tools and techniques.

As shown in FIG. 10, the communication device 1000 includes a processor 1010, a memory 1020, one or more displays 1030, and one or more input devices 1040. The memory 020 generally includes both volatile memory (e.g., RAM) and non-volatile memory (e.g., ROM, Flash Memory, or the like). The communication device 1000 includes an operating system 1022, such as the Windows Mobile operating system from Microsoft Corporation or other such operating system, which is resident in the memory 1020 and executes on the processor 1010. The input devices 1040 may include one or more keypads. Each keypad may be a push-button numeric dialing pad (such as on a typical telephone) or a multi-key keyboard (such as a conventional keyboard). One or more keypads may be sliding, in that the keypad can slide at least partially into or under the communication device 1000 reducing the overall footprint. Other input devices, such as click-wheels, touch pads, navigation buttons, joysticks, and so forth, may also be included. The display 1030 may be a liquid crystal display, or any other type of display commonly used in mobile computing devices. For example, the display 1030 may be touch-sensitive, and would then also act as an input device. There may be multiple displays including a primary, larger, display 1030, and a smaller, secondary display 1030.

One or more application programs 1024 are loaded into the memory 1020 and run on the operating system 1022. Examples of application programs include phone dialer programs, a switch manager, e-mail programs, calendar programs, word processing programs, spreadsheet programs, media play programs, camera function programs, and so forth. The operating system 1022 may also contain a program designed intelligently search the options available on the communication device 1000. The communication device 1000 also includes a non-volatile storage 1026 within the memory 1020. The non-volatile storage 1026 may be used to store persistent information which should not be lost if the communication device 1000 is powered down. The application programs 1024 may use and store information in the storage 1026, such as e-mail, SMS, MMS, or other messages used by an e-mail application, appointment information used by a calendar program, documents used by a word processing application, playlists and songs available to be accessed through a music program, pictures stored by a camera program, as well as videos, game states, and the like.

A synchronization application may also reside on the communication device 1000 and is programmed to interact with a corresponding synchronization application resident on a host computer to keep the information stored in the storage 1026 synchronized with corresponding information stored at the host computer.

A global positioning system may also be included on the communication device 1000, which can be used to track the location of the communication device 1000, and can also be used by the device user to determine his or her location, or the device itself can use the physical location in tandem with the application programs 1024 to perform location-dependent actions.

The communication device 1000 also includes a power supply 1050, which may be implemented as one or more batteries. The power supply 1050 might further include an external power source, such as an AC adapter or a powered docking cradle that supplements or recharges the batteries.

The communication device 1000 is also shown with two types of external notification mechanisms: an LED 1060 and an audio interface 1070. Other components, such as one or more of the displays 1030, and vibration devices (not shown) may also operate as notification mechanisms. These devices may be directly coupled to the power supply 1050 so that when activated, they remain on for a duration dictated by the notification mechanism even though the processor 1010 and other components might shut down to conserve battery power. The LED 1060 may be programmed to remain on indefinitely until the user takes action to indicate the powered-on status of the device. The audio interface 1070 is used to provide audible signals to and receive audible signals from the user. For example, the audio interface 1070 may be coupled to a speaker for providing audible output and to a microphone for receiving audible input, such as to facilitate a telephone conversation. A camera device 1075 may also be included.

The communication device 1000 also includes a radio 1080 that performs the function of transmitting and receiving radio frequency communication. The radio 1080 facilitates wireless connectivity between the communication device 1000 and the outside world, for example via a communication carrier or service provider. Transmissions to and from the radio 1080 are conducted under control of the operating system 1022. In other words, communications received by the radio 1080 may be disseminated to the application programs 1024 via the operating system 1022, and vice-versa.

The radio 1080 allows the communication device 1000 to communicate with other computing devices, such as over a network. The radio 1080 is an example of communication media discussed above.

VI. Alternatives

Having described and illustrated the principles of our invention with reference to the illustrated embodiments, it will be recognized that the illustrated embodiments can be modified in arrangement and detail without departing from such principles.

Elements of the illustrated embodiment shown in software may be implemented in hardware and vice-versa. Also, the technologies from any example can be combined with the technologies described in any one or more of the other examples.

In view of the many possible embodiments to which the principles of the invention may be applied, it should be recognized that the illustrated embodiments are examples of the invention and should not be taken as a limitation on the scope of the invention. For instance, various components of systems and tools described herein may be combined in function and use. We therefore claim as our invention all subject matter that comes within the scope and spirit of these claims.

1-20. (canceled)

21. A method for displaying an advertisement on an electronic device comprising:
receiving a keyword input from a user;
displaying an advertisement associated with the keyword, wherein the advertisement is stored on the device;
transmitting a signal to a remote site indicating that the advertisement was displayed.

22. The method of claim 21 wherein the electronic device is a portable communications device.

23. The method of claim 21 wherein the advertiser pays a fee to add the advertisement to the database of advertisements.

24. The method of claim 21 wherein the device includes an option which if selected disables the advertisement such that it is not displayed when the keyword associated with the advertisement is selected.

25. The method of claim 24 wherein the advertisement is displayed only if the user is paid a fee.

26. The method of claim 21 wherein the sending to a remote site further comprises sending an indication of an identity of the user to the remote site.

27. The method of claim 26 wherein the user can block the sending an indication of an identity of the user to the remote site.

28. The method of claim 26 wherein the sending to a remote site occurs at a predetermined time.

29. The method of claim 21 further comprising the advertiser paying a fee associated with the indication that the advertisement has been displayed.

30. The method of claim 29 further comprising the user receiving at least a portion of the fee paid by the advertiser.

31. The method of claim 30 wherein the advertisement is added to the database of advertisements without the user's knowledge.

32. The method of claim 31 further comprising at least two advertisements associated with the advertiser and wherein one advertisement is chosen based on a physical location of the device.

33. A method to display an advertisement on a portable electronic device, comprising
responding to ambiguous input from a user;
mapping the ambiguous input to a precise mapping to produce an expanded lookup set;
using the expanded lookup set to search a database of keywords located on the portable electronic device producing keyword results, the keyword results comprising at least one keyword associated with an advertisement located on the portable electronic device;
displaying the at least one keyword associated with the advertisement;
registering that the user has chosen the at least one keyword associated with the advertisement; and
displaying the advertisement.

34. The method of claim 33 wherein the ambiguous input comprises one of voice recognition input, handwriting recognition input or keyboard input.

35. The method of claim 33 wherein an advertiser pays to have the advertisement associated with the keyword.

36. The method of claim 33 wherein the keyword results comprise a keyword list comprising at least two keywords, and wherein the device uses a user history to determine the order of the keyword list.

37. The method of claim 33 wherein displaying the advertisement comprises at least one of: displaying a picture on a screen, playing a message on a speaker, sending an email to an account associated with the user, connecting the device with an Internet site; playing a video clip, or sending a text message to the device.

38. A system for recording that an advertisement has been played on a portable media device in response to a user search action, comprising
a keyword database which hold keywords representing at least applications available on the portable media device, paid placements, device options, advertisements, and services available through the device;
an advertisement database which holds at least one advertisement;
a displayer which locates and sorts keywords in the keyword database associated with the user search action into a sorted keyword list;
a user monitor which records which keyword in the sorted keyword list a user has chosen;
a keyword-advertisement associator which associates at least one keyword with the at least one advertisement;
an advertisement displayer which displays the at least one advertisement when the keyword the user has chosen is associated by the associator with the at least one advertisement; and
an advertisement recorder which records that the advertisement has been displayed.

39. The system of claim 38 further comprising an advertisement payment maker which pays a fee associated with the advertisement being displayed.

40. The system of claim 38 wherein the advertisement recorder sends a message to a different device when the advertisement is viewed.
